(19) United States
(12) Patent Application Publication
(10) Pub. No.: US 2007/0130149 A1
(43) Pub. Date: Jun. 7, 2007

(54) Method, system, and computer program product for troubleshooting/configuring communications settings of a computer system

(75) Inventors: Scott Edwards Kelso, Durham, NC (US); John Carl Mese, Cary, NC (US); Nathan J. Peterson, Raleigh, NC (US); Rod David Waltermann, Durham, NC (US); Arnold S. Weksler, Raleigh, NC (US)

Correspondence Address: SYNNESTVEDT & LECHNER, LLP, 1101 MARKET STREET, 26TH FLOOR, PHILADELPHIA, PA, 19107-2950, US

(73) Assignee: Lenovo (Singapore) Pte. Ltd., Singapore (SG)

(21) Appl. No.: 11/249,062

(22) Filed: Oct. 12, 2005

(51) Int. Cl. G06F 17/30; G06F 7/00

(52) U.S. Cl. 707/10

(57) ABSTRACT

The present invention provides a client and server tool that interrogates file sharing attributes of a client/server system from both the client side and the server side. These attributes may include software fireballs, sharing policies, and security attributes. By interrogating the file sharing attributes from both the client and server sides, network access problems emanating from entire side (client and server) can be discovered, and automated solutions can be presented to rectify any problems.

### BACKGROUND OF THE INVENTION

1. Field of the Invention

This invention relates to generally to computer systems, and, more particularly, to a method and apparatus for troubleshooting and configuring communications settings in a computer system.

2. Description of the Related Art

The networking of individual computers to allow an application program and file resources to be shared by users of the computers is a well-known concept. In particular, business entities, from large corporations to relatively small companies, routinely set up local area networks (LANs) and wide area networks (WANs) to enable such application file sharing throughout the enterprise.

NetBIOS (network basic input/output system) was developed as an application programming interface (API) for client software to access network resources. NetBIOS standardizes the interface between applications and the operating capabilities of the network. PCs on a NetBIOS LAN communicate either by establishing a session or by using NetBIOS datagram or broadcast methods. These methods are well known and are not discussed further herein.

Setting up NetBIOS file sharing between two or more computers in the same domain (e.g., on the same side of a hardware firewall) is not always a straight-forward process. In addition to having to configure the software firewall settings, there are several operating system configuration values that must be set correctly. Failure to set any one of the values correctly can result in an inability to share files and/or directories and thus may require a significant amount of diagnostic or troubleshooting information to get the system operating properly.

For a network administrator, bringing up a computer on a network can typically be resolved by the network administrator trying a series of known troubleshooting options until one of them works. If the problem can be resolved using one of these known fixes, the computer can be brought up without much difficulty. However, if the network administrator goes through the known troubleshooting options and still cannot access the network, significant additional time can be wasted further troubleshooting the issue.

The problem is magnified when a general consumer, who does not have the knowledge and expertise of a network administrator, attempts to access the network. Operating systems are not very helpful in guiding the consumer through the process. This leaves the consumer frustrated and unable to connect to the network.

Accordingly, it would be desirable to have a method, system, and computer program product that assists users in diagnosing and correcting network connectivity problems.

### SUMMARY OF THE INVENTION

The present invention provides a client and server tool that interrogates security attributes of a client/server system from both the client side and the server side. These attributes may include software firewalls, sharing policies, and security attributes. By interrogating the security attributes from both the client and server sides, network access problems emanating from entire side (client and server) can be discovered, and automated solutions can be presented to rectify any problems.

### BRIEF DESCRIPTION OF THE DRAWINGS

FIG. 1 is a block diagram of a typical computer network;

FIG. 2 illustrates the typical security layers that are established in a typical client server system;

FIG. 3 illustrates a solution to the above problem in accordance with the present invention;

FIG. 4 is a flowchart illustrating the steps performed by the client agent of the present invention;

FIG. 5 is a flowchart illustrating the same steps of FIG. 4, but from the perspective of the server agent rather than the client agent; and

FIG. 6 is a flowchart illustrating operations performed by the comparison processor using the results from the testing steps performed by the client agent and server agent.

### DETAILED DESCRIPTION OF THE PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions will be made to achieve the developers specific goals, such as compliance with system-related and business-related constraints, which will vary from one implementation to another. Moreover, it will be appreciated that such a development effort would be a routine undertaking for those of ordinary skill in the art having the benefit of this disclosure.

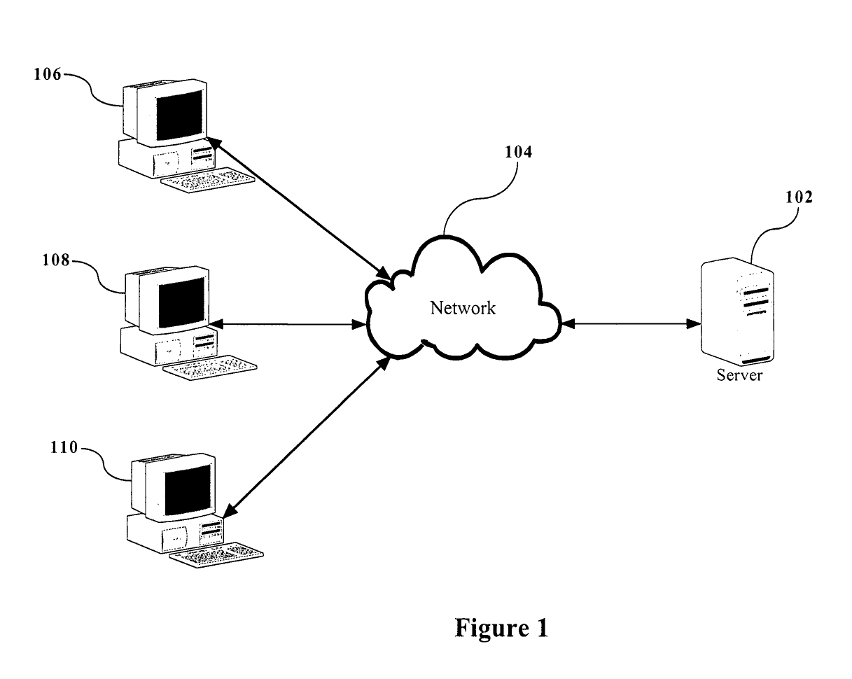

Referring to FIG. 1, a block diagram of a typical computer network 100 is shown. It is understood that the various connections between the elements of the network may be wired, wireless, or combinations thereof. The exact technique for coupling the elements of the system are those up to the discretion of the developer and are not critical to the inventive aspects described.

Referring to FIG. 1, a server 102 is accessible to a plurality of client devices 106, 108, and 110, via a network connection 104. Network connection 104 can comprise any network connection, such as the Internet, a local area network (LAN) a wide area network (WAN), or the like. In a well known manner, server 102 and client devices 106, 108, and 110 can communicate with each other via the well-known ports that are available on a network system. Examples of such ports include, but are not limited to, network share, mail, FTP, and HTTP. When a client device connects to the server via one of these ports, a channel or conduit between the client device and the server is established.

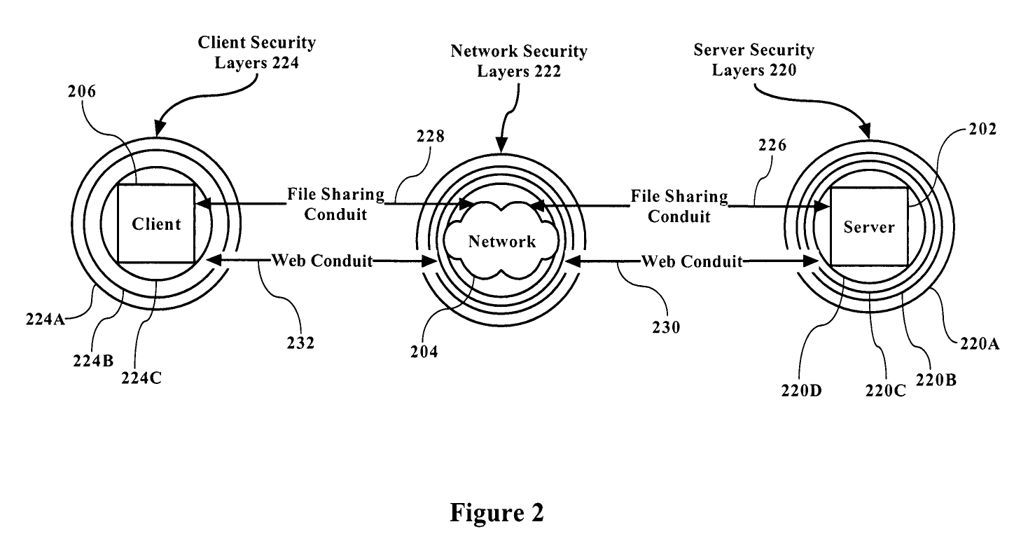

FIG. 2 illustrates the typical security layers that are established in a typical client server system. Referring to FIG. 2, a server 202 connects with a client 206 over a network connection 204. Each element of the network (server, network connection, and client) are protected by security layers in a well known manner. In FIG. 2, server security layers 220 (comprising, in this example, a net firewall layer 220A, a sharing configuration layer 220B, a policy layer 220C, and an attributes layer 220D) provide security protection for server 202; network security layers 222 provide security protection for network connection 204; and client security layers 224 (comprising, in this example, network service, layers 224A, software firewall layers 224B, at net layer 224C) provide security protection for client 206. The layers described by way of example are well known to those of ordinary skill in the art. It is understood that there are other layers of security that could be added to those given in this example and such variations are covered by the claims herein.

If client 206 wishes to connect to server 202 for the purpose of file sharing, client 206 must navigate through client security layers 224 and network security layers 222 to establish a file sharing channel 228 with network connection 204. To complete the file sharing connection, file sharing conduit 226 must be established between network connection 204 and server 202 through network security layers 222 and server security layers 220. To make this connection through the various security layers, the software firewall settings for the client, server, and routers allowing client 206 to navigate through software firewall layer 224B must be configured properly, and there are several OS configuration values that must be set correctly, e.g., user authentication such as Keberos. Failure to set any one of the OS configuration values may result in a failure in the attempt to establish the file sharing conduit 226.

Also illustrated FIG. 2 is a web conduit between client 206 and server to 202 via network connection 204. The web ports for TCP/IP (ports 80 and 443) are almost always open and thus the security layers that must be traversed to establish a Web connection are typically very minimal. This is illustrated symbolically in FIG. 2 by the openings in client security layers 224, network security layers 222 and server security layers 220, through which web conduits 232 and 230 are established to link the client to the server for a web connection.

For one having knowledge of all of the configuration settings required to establish the file sharing conduit, it may not be too difficult to establish such a connection. A network administrator typically knows what the settings should be, and is also aware of the various troubleshooting steps to take in order to analyze any problems and come up with a solution that will eventually enable the establishment of the file sharing conduit. However, the average user (e.g., a mobile user who is attempting to configure a laptop to access a network in a remote location such as a hotel or office he or she is visiting) may not have the knowledge and skill required to go through the troubleshooting process. This average user typically will attempt to connect, will experience a problem, may try one or two solutions that have worked for them in the past, and then give up attempting to connect.

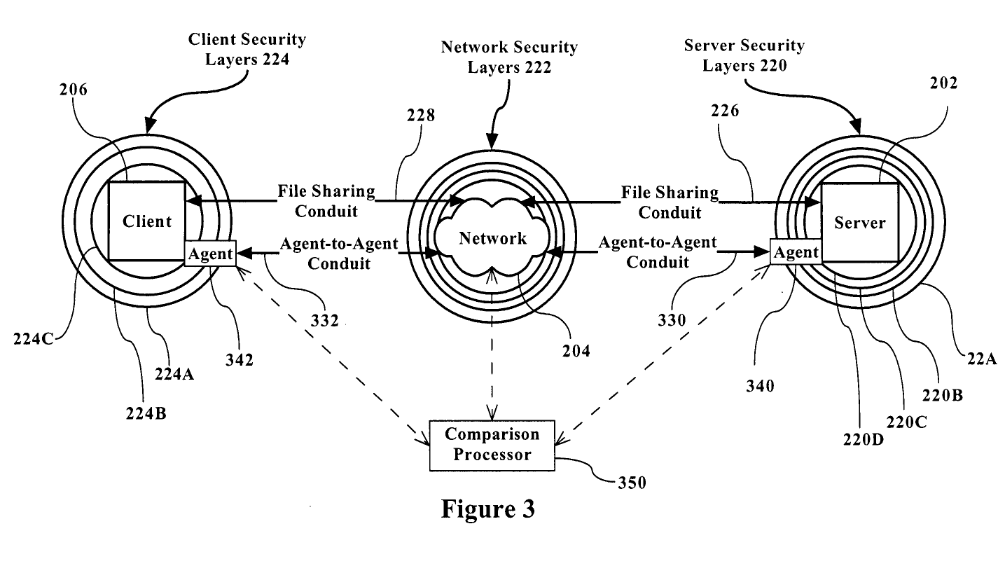

FIG. 3 illustrates a solution to the above problem in accordance with the present invention. Items in FIG. 3 that are identical to items in FIG. 2 are identified using the same numerals as used in FIG. 2. Referring to FIG. 3, server 202 and client 206 are each provided with a software agent (client software agents (CSA) 340 and server software agents (SSA) 342, respectively). In a preferred embodiment at least two conduits are established between the client and server. The first is a main conduit that carries the user data, such as files that are being shared. In FIG. 3, this main conduit comprises two file sharing conduits 226 and 228. The second is an agent-to-agent conduit that should be an easy-to-access connection that has a high likelihood of being easily established. In the example of FIG. 3, web conduit 230 and 232 provide a good agent-to-agent conduit, since web ports are almost always open, and users will complain (and thus alert administrators) if it goes down.

Each of the agents are configured with rules that interrogate the file sharing attributes of the respective components (client or server) including the software firewalls, the sharing policies, and the security attributes. To troubleshoot a network sharing issue, the agents are each configured to diagnose a section of the security layers accessible to them. For example, the firewall security layer of either the server or the client (or both) may be blocking the standard Windows share ports 137 to 139. When the client tries to connect to the server, it would get no response if the firewall is blocking the ports; however, if the port is open but the server is not running the network sharing service, the server will return an indication that the port is closed. Using the probing technique of the present invention, the client agent can determine the status of the outer layer of the server security model (the firewall is always the outermost defense, and is sometimes referred to as a “boundary device”) and present multiple options for correcting any problems encountered, e.g., send instructions to the server over the agent-to-agent conduit to instruct it to run the network sharing service. All of this functionality can be accomplished using known techniques to define and execute the various probing operations discussed herein.

The server agent 340 will first test the components beneath its firewall (firewall layer 220A), i.e., the inner layers 220B, 220C, and 220D denoted in FIG. 3. For example, the server agent 340 can check the policy and sharing configuration to see if they are set up correctly. Following is an example of a list of steps the server agent 340 can perform to test the security layers. The list is not exhaustive and is simply a list of common testing steps. The server agent 340 can check to see if a service is running for sharing (NetBIOS); check to see if sharing is enabled; check to see if at least one resource is shared; check to see if at least one user/group is enabled; check to see if permissions and policies are set; and perform client based activities through loop back.

The client agent 342 can perform internal tests to determine network availability. These may include NIC card configuration, the IP address configuration, and/or the NetBIOS service configuration. The client agent 342 can also perform external tests, including probing of the firewall, NetView data on the server, and NSlook up of server address data.

The tests listed above are given for purpose of example. Any tests that can be performed on the server and/or client can be performed by an agent configured to conduct the test(s). Installation of the server and client agent establishes, on both ends of the path to be monitored and tested, a testing and analysis means. The agents are configured with appropriate permissions to cross the security layers of the machine on which the agent is running, and can communicate directly with each other via, for example, the easily established web conduit. The agents use standard networking APIs including ping, Nslookup, net use, and NetView to heuristically analyze the data shared between clients and server. The result of this analysis can be shared between the agents, or individually output to external media for analysis by troubleshooters.

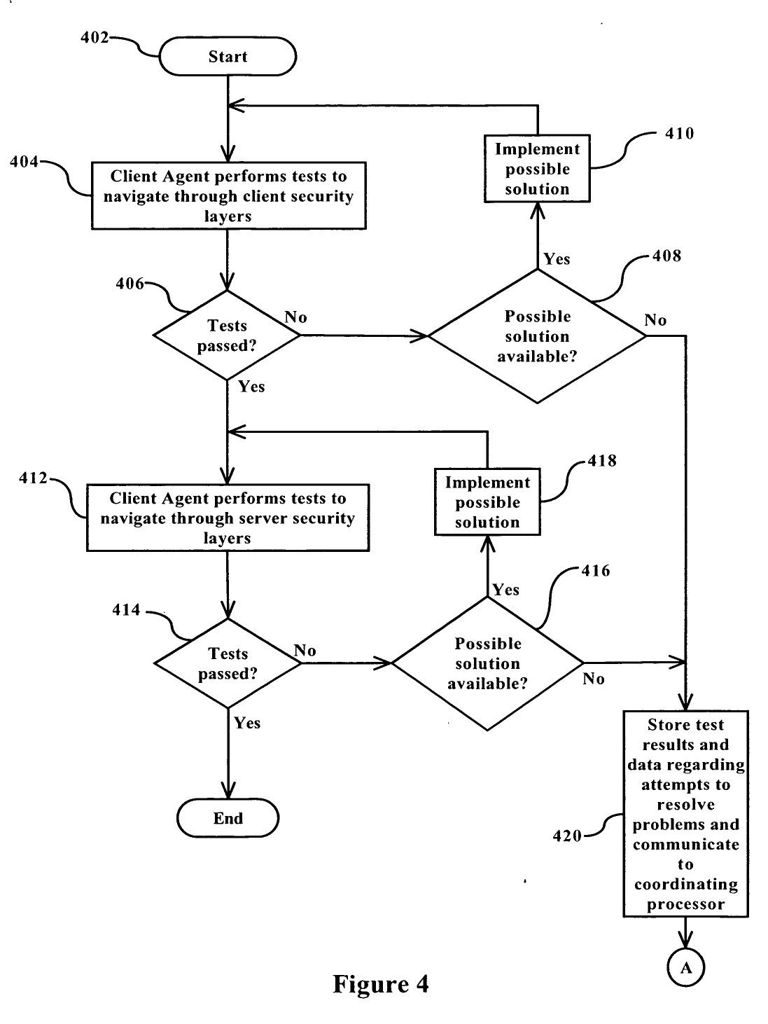

FIGS. 4 through 6 are flowcharts illustrating the basic operations of an exemplary embodiment of the present invention. FIG. 4 is a flowchart illustrating the steps performed by the client agent. The process begins at step 402, and at step 404 the client agent performs tests to navigate through the client security layers. At step 406, a determination is made as to whether or not the tests have passed. If one or more of the tests are not passed, at step 408, a determination is made as to whether or not there is a possible solution available to correct the test failure.

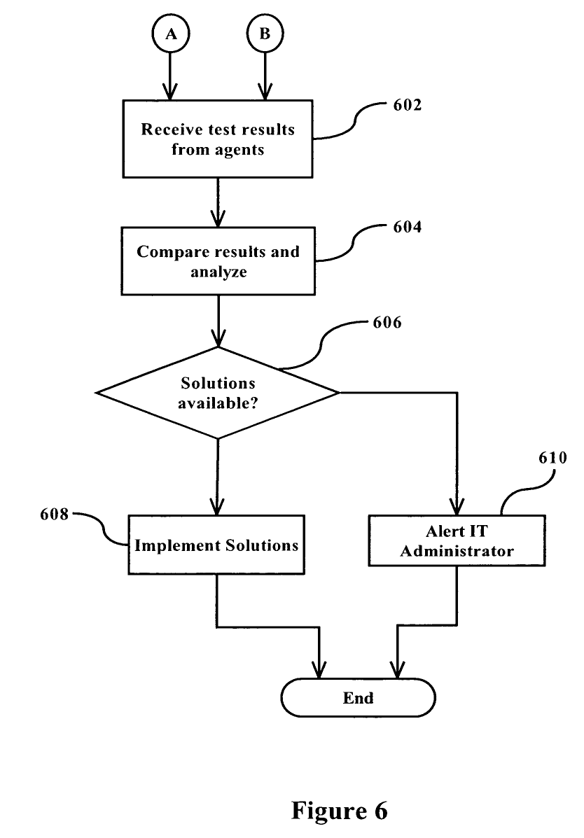

If, at step 408, is determined that there are possible solutions available to correct the test failure, at step 410, the possible solutions are implemented and then the process proceeds back to step 402 to again perform the tests to navigate through the client security layers, to see if the problems have been resolved. If there are no possible solutions available, at step 420 the client agent stores this information and communicates the results to a “coordinating processor,” described in more detail below with respect to FIG. 6.

If, at step 406, it is determined that the client security layer tests have been passed, the process proceeds to step 412, where the client agent performs tests to navigate through the server security layers. At step 414, a determination is made as to whether or not the tests have been passed. If the tests indicate a failure, at step 416 a determination is made as to whether not there are possible solutions available to resolve the failure. If there are possible solutions available, at step 418 the possible solutions are implemented, and then the client agent retests the server security layers. If, at step 416, it is determined that there are not any possible solutions available, information identifying failures and failed attempts at resolution are saved and communicated to the coordinating processor at step 420.

If, at step 414, all of the tests have passed, this is an indication that the connections between the client and server are functioning properly, and the process ends.

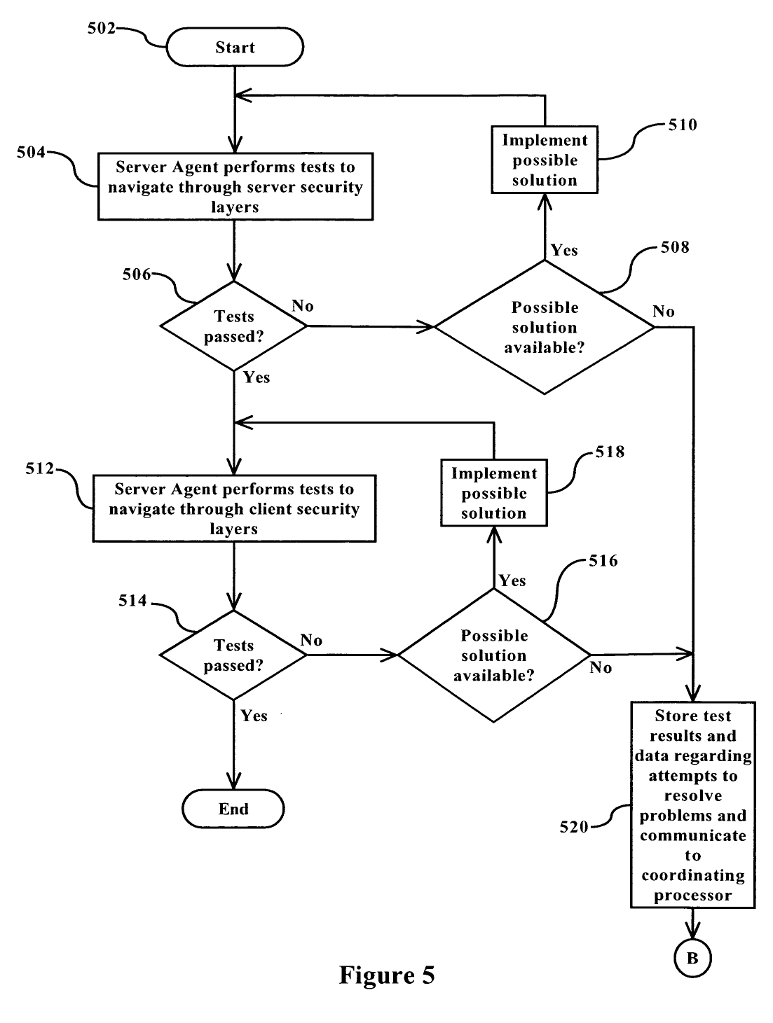

FIG. 5 is a flowchart illustrating the same steps of FIG. 4, but from the perspective of the server agent rather than the client agent. Since the steps are essentially identical to those of FIG. 4 and are apparent from the drawing, they are not described in detail herein. The only difference between FIG. 4 and FIG. 5 is that in steps 504 and 512, the server agent performs the tests rather than the client agent. It is noted that in the flowcharts of FIGS. 4 and 5, only information regarding test results (e.g., pass/fail) and attempts to resolve problems are shown as being communicated to the coordinating processor. It is contemplated, however, that information regarding successful problem resolutions (i.e., not just attempts to resolve problems) and any other data available regarding the process steps of FIGS. 4 and 5 may be useful to the coordinating processor and thus any of this data may be communicated thereto.

FIG. 6 is a flowchart illustrating operations performed by the coordinating processor using the results from the testing steps performed by the client agent and server agent as described in FIGS. 4 and 5. The coordinating processor can be a processor integrated or associated with the client, the server, or both; the coordinating processor can also be a processor that is independent from the client and server. In FIG. 3, coordinatig processor 350 is shown in dotted lines to indicate that it is a functional illustration only; in a preferred embodiment, the coordinating processor is a processing function residing with and performed by the client agent. However, either the client agent or the server agent, or both, can be configured to function as a coordinating processor.

The coordinating processor is configured to perform the steps described herein using well-known programming techniques. At step 602, the testing results and other troubleshooting results are received by the coordinating processor from the client agent and the server agent. At step 604, the coordinating processor compares the results and analyzes them, and at step 606 it is determined if there are solutions available to resolve problems associated with any test failures that have been encountered. If there are solutions available, then at step 608, the solutions are implemented by the coordinating processor, e.g., the coordinating processor might send an instruction to the client or server to open a particular port or to change a particular communication setting. If there are not solutions available, then at step 610, an IT administrator or other responsible party is alerted, since problems have been encountered that require the assistance of administrative personnel.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-2 support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A system for configuring or troubleshooting a computer network, comprising:
one or more client devices, each client device configured with a client software agent (CSA);
one or more servers, each server configured with a server software agent (SSA);
one or more network connections coupling said one or more client devices to said one or more servers; and
a coordinating processor in communication with said one or more client devices and said one or more servers;
wherein:
each said CSA is configured to probe security layers protecting its client and forward data pertaining to the probe to said coordinating processor;
each said SSA is configured to probe security layers protecting its server and forward data pertaining to the probe to said coordinating processor; and
said coordinating processor is configured to analyze data received from each CSA and SSA, identify configuration issues respecting said one or more clients and said one or more servers, and implement solutions to handle any identified configuration issues.

2. The system of claim 1, wherein said coordinating processor is configured into each CSA.

3. The system of claim 1, wherein said coordinating processor is configured into each SSA.

4. The system of claim 1, wherein said coordinating processor is configured into each CSA and each SSA.

5. The system of claim 1, wherein said coordinating processor is a separate agent independent of each CSA and each SSA.

6. A computer-implemented method for configuring or troubleshooting a computer network having one or more client devices, one or more servers, and one or more network connections coupling said one or more client devices to said one or more servers, comprising:
configuring each client device with a client software agent (CSA);
configuring each server with a server software agent (SSA); and
coupling a coordinating processor with said one or more client devices and said one or more servers;
wherein:
each said CSA is configured to probe security layers protecting its client and forward data pertaining to the probe to said coordinating processor;
each said SSA is configured to probe security layers protecting its server and forward data pertaining to the probe to said coordinating processor; and
said coordinating processor is configured to analyze data received from each CSA and SSA, identify configuration issues respecting said one or more clients and said one or more servers, and implement solutions to handle any identified configuration issues.

7. The method of claim 6, wherein said coordinating processor is configured into each CSA.

8. The method of claim 6, wherein said coordinating processor is configured into each SSA.

9. The method of claim 6, wherein said coordinating processor is configured into each CSA and each SSA.

10. The method of claim 1, wherein said coordinating processor is a separate agent independent of each CSA and each SSA.

11. A computer-implemented computer program product for configuring or troubleshooting a computer network having one or more client devices, one or more servers, and one or more network connections coupling said one or more client devices to said one or more servers, the computer program product comprising a computer-readable storage medium having computer-readable program code embodied in the medium, the computer-readable program code comprising:
computer-readable program code that configures each client device with a client software agent (CSA);
computer-readable program code that configures each server with a server software agent (SSA); and
computer-readable program code that couples a coordinating processor with said one or more client devices and said one or more servers;
wherein:
each said CSA is configured to probe security layers protecting its client and forward data pertaining to the probe to said coordinating processor;
each said SSA is configured to probe security layers protecting its server and forward data pertaining to the probe to said coordinating processor; and
said coordinating processor is configured to analyze data received from each CSA and SSA, identify configuration issues respecting said one or more clients and said one or more servers, and implement solutions to handle any identified configuration issues.

12. The computer program product of claim 11, wherein said coordinating processor is configured into each CSA.

13. The computer program product of claim 11, wherein said coordinating processor is configured into each SSA.

14. The computer program product of claim 11, wherein said coordinating processor is configured into each CSA and each SSA.

15. The computer program product of claim 1, wherein said coordinating processor is a separate agent independent of each CSA and each SSA.
